(19) United States
(12) Patent Application Publication
(10) Pub. No.: US 2019/0026594 A1
(43) Pub. Date: Jan. 24, 2019

(54) WINE LABEL IMAGE IDENTIFYING METHOD

(71) Applicant: Good Courage Limited, Cayman Islands (KY)

(72) Inventor: Sheng LIN, Taipei City (TW)

(21) Appl. No.: 15/656,809

(22) Filed: Jul. 21, 2017

(51) Int. Cl. G06K 9/62; G06T 7/11

(52) U.S. Cl. CPC G06K 9/6202; G06T 7/11

(57) ABSTRACT

A wine label image identifying method has steps of capturing a target image by a mobile device; sampling multiple first points in an upper reference zone of the target image and sampling multiple second points positioned in a lower reference zone of the target image; determining whether a first average gray scale value of the multiple first points and the multiple second points is lower than a first gray scale threshold; sampling multiple third points of the target image when the first average gray scale value is lower than the first gray scale threshold; and determining whether a second average gray scale value of the multiple third points is higher than a second gray scale threshold. When the second average gray scale value is higher than the second gray scale threshold, it is confirmed that a wine label is captured in the target image.

### BACKGROUND OF THE INVENTION

### 1. Field of the Invention

The present invention relates to a label image identifying method, especially a label image identifying method capable of automatically capturing a wine label.

### 2. Description of the Prior Arts

With improvement of people's living standard, various wines, not only kaoliang spirit and Shaoxing rice wine but also grape wine, champagne, whisky, etc., are accepted by the general public. However, there is a large amount of trademarks of the wines, with more than 1000 trademarks merely in the grape wine, and thus it is difficult to identify the wine via exterior appearance and name. In order to identify a wine, a customer needs to search for a name on a label of a wine via Internet and then compares the results with the wine.

Another way is to identify the wine via a wine label. But different wines have different wine labels, some labels are marked on a tag while some are mint-marked on the bottles, and the sizes, colors, shapes and typefaces of the labels are all different. Thus identifying of the image of a wine label needs to be resolved.

### SUMMARY OF THE INVENTION

The present invention provides a wine label image identifying method. The method comprises steps of:
capturing a target image by a mobile device;
sampling multiple first points in an upper reference zone of the target image and sampling multiple second points positioned in a lower reference zone of the target image;
determining whether a first average gray scale value of the multiple first points and the multiple second points is lower than a first gray scale threshold;
sampling multiple third points of the target image when the first average gray scale value is lower than the first gray scale threshold;
determining whether a second average gray scale value of the multiple third points is higher than a second gray scale threshold;
when the second average gray scale value is higher than the second gray scale threshold, confirming that a wine label is captured in the target image.

The label image identifying method may automatically scan the target image and determine whether the target image contains a wine label image therein.

### BRIEF DESCRIPTION OF THE DRAWINGS

FIG. 1A is an operational view of capturing a wine label in accordance with the present invention;

FIG. 1B shows a plurality of sampled points of a captured image for identifying the wine label;

FIG. 2 is a flow chart of a wine label image identifying method of the present invention; and

FIG. 3 is a block diagram of a wine label image identifying device of the present invention.

### DETAILED DESCRIPTION OF THE INVENTION

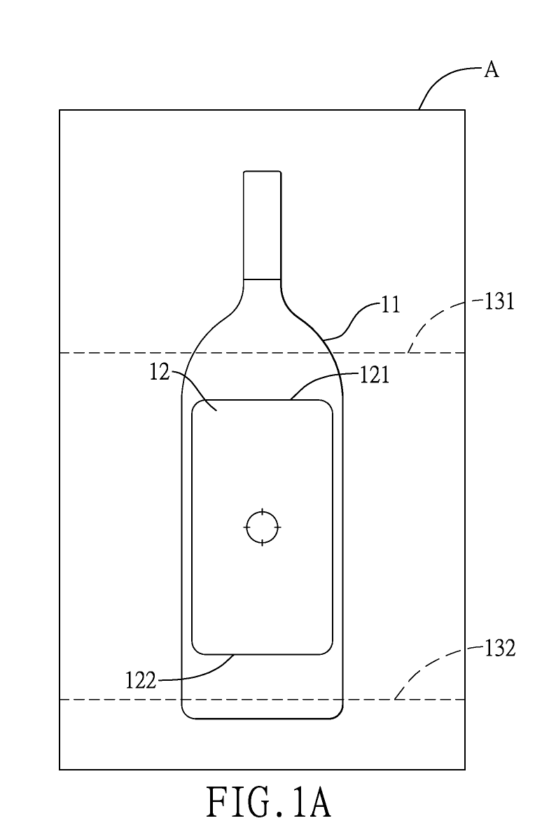

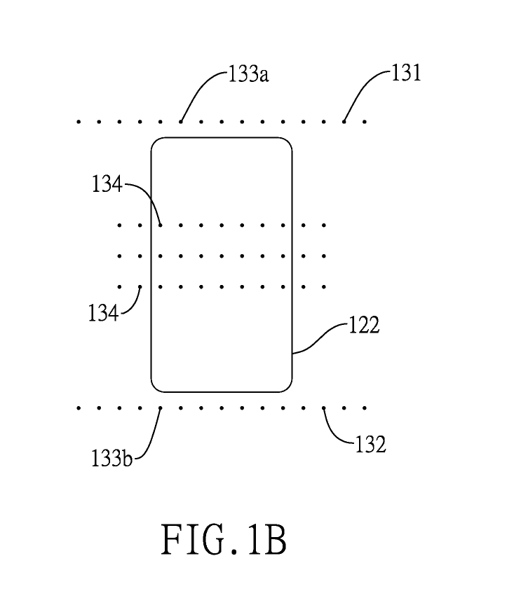

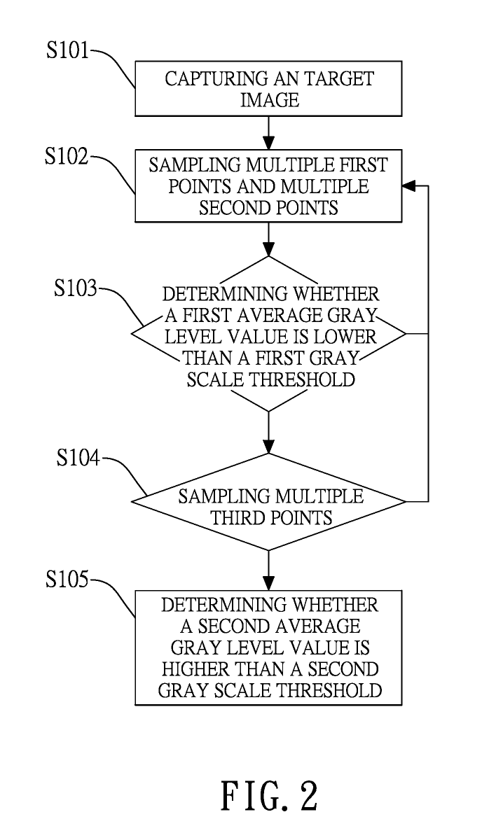

As shown in FIG. 1A, FIG. 1B and FIG. 2, a wine label image identifying method comprises the following steps. In the step S101, an image software of a mobile device is launched, while the image software may activate an image capturing function of the mobile device to capture a target image A to be identified. For example, the image software is a camera software installed in the mobile device.

Although wine labels 12 on bottles 11 are of various shapes, the wine labels 12 still have obvious characteristics for reading expediently. The bottle 11 and the wine label 12 are different in their gray-scale images. In step S102, an upper reference zone 131 and a lower reference zone 132 are applied to determine whether the target image is properly captured by the mobile device. The positions of the upper reference zone 131 and the lower reference zone 132 are predetermined. To determine whether the target image is properly captured, some points of the target image will be sampled for calculating a gray scale value.

For instance, if the camera resolution of the mobile device is 1280*720 pixels, multiple first points 133a of the target image are sampled and the positions of the multiple first points are in the upper reference zone 131, and multiple second points 133b of the target image are sampled and the positions of the multiple first points 133a are in the lower reference zone 132. Each of the first points 133a and the second points 133b may be one or more pixels of the target image.

The coordinates of the sampled first points 133a within the upper reference zone 131 and the sampled second points 133b within the lower reference zone 132 are shown in the following table:

| First points sampled within the | Second points sampled within the |
|---|---|
| upper reference zone | lower reference zone |
| (187, 4) | (211, 1250) |
| (487, 7) | (601, 1243) |
| (254, 10) | (451, 1255) |
| (360, 15) | (313, 1260) |
| (503, 17) | (153, 1265) |
| (287, 20) | (577, 1270) |
| | (487, 1275) |

Each first point 133a and each second point 133b has a respective gray scale value. By dividing the sum of all gray scale values of the first points 133a and the second points 133b by a total number of the first points 133a and the second points, a first average gray scale value is obtained. In step S103, the first average gray scale value of the multiple first points 133a and the multiple second points 133b is compared with a first gray scale threshold. The first gray scale threshold is a critical value for confirming whether the captured image is a valid target image containing a wine bottle. If the first average gray scale value of the multiple first points 133a and the second points 133b is lower than the first gray scale threshold, it means that the wine bottle has been captured in the valid target image. In the present invention, the first gray scale threshold is optimized as 50. In other embodiments, the first gray scale threshold may be between 50 and 75.

After the target image is confirmed as the valid target image, in step S104, multiple third points 134 of the target image are sampled and a second average gray scale value of the third points 134 is calculated. Each of the third points 134 may be one or more pixels of the valid target image. The second average gray scale is calculated by dividing the sum of the gray scale values of all third points 134 by the total number of the third points 134.

In step S105, the second average gray scale value is compared with a second gray scale threshold. If the second average gray scale value is higher than the second gray scale threshold, it is confirmed that a wine label is captured in the valid target image. Otherwise, if the second average gray scale value is lower than the second gray scale threshold, the valid target image does not contain the wine label image. A preferred value of the second gray scale threshold is 65, while in other embodiments, the second gray scale threshold may be within a range from the first gray scale threshold plus 10 to the first gray scale threshold plus 15.

According to statistics, the gray scale value of a wine label should be slightly higher. Thus, if the second average gray scale value of the sampled multiple third points 134 is higher than the second gray scale threshold, it means the multiple third points 134 have higher gray scale values, and hence the target image should contain a wine label image.

Moreover, the amount of the multiple third points 134 to be sampled may be determined on demand. For instance, the amount of the multiple third points 134 may be increased when a higher accuracy of the identification is needed. Meanwhile, the present invention has a Deep Learning function. When the accuracy of the identification is low, the amount of the multiple third points 134 is automatically increased to promote the accuracy by the Deep Learning function. The Deep Learning function is based on neural networks machine learning technology.

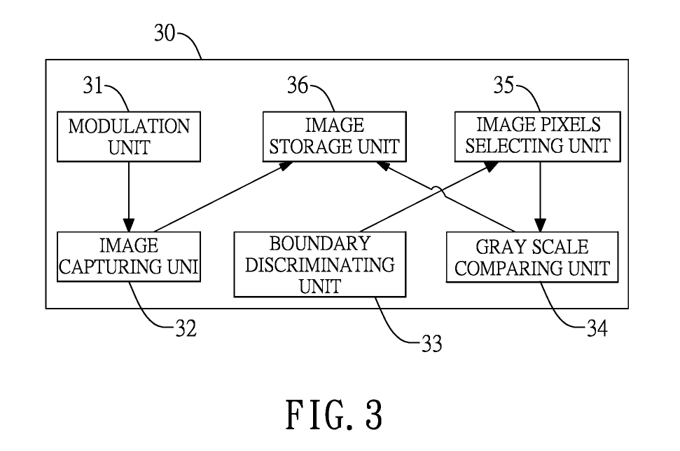

With reference to FIG. 3, the wine label image identifying device 30 comprises a modulation unit 31, an image capturing unit 32, a boundary discriminating unit 33, a gray scale comparing unit 34, an image pixels selecting unit 35 and an image storage unit 36.

The image capturing unit 32 is connected to the modulation unit 31, the boundary discrimination unit 33 is connected to the image capturing unit 32, the gray scale comparing unit 34 is connected to the boundary discriminating unit 33, the image pixels selecting unit 35 is connected to the boundary discriminating unit 33 and the gray scale comparing unit 34, and the image storage unit 36 is connected to the image capturing unit 32 and the gray scale comparing unit 34.

The image resolution of the wine label image identifying device 30 is determined by the modulation unit 31. The wine label image identifying device 30 may be incorporated in the mobile device. Different mobile devices have different image resolutions and different viewing scopes. In one embodiment, the coordinate positions of the upper reference zone 131 and the lower reference zone 132 to be captured vary with the image resolutions.

After the image resolution is identified, the image capturing unit 32 is used to capture a target image. The boundary discrimination unit 33 receives the target image and transmits the target image to the gray scale comparing unit 34. The gray scale comparing unit 34 compares the first average gray scale value with the first gray scale threshold. If the first average gray scale value is lower than the first gray scale threshold, the target image is identified as a valid target image.

The image pixels selecting unit 35 receives the target image from the boundary discriminating unit 33 and selects multiple third points 134 of the valid target image. The gray scale comparing unit 34 compares a second average gray scale value of the multiple third points 134 with a second gray scale threshold. If the first gray scale value is lower than the first gray scale threshold, and the second average gray scale value is higher than the second gray scale threshold, a wine label in the target image is confirmed. A confirmation message may be sent to the image storage unit 36.

When the image storage unit 36 receives the confirmation message, the target image is stored in the wine label image identifying device 30. The target image that is confirmed as having the wine label image may be further transmitted to another application software to determine the kind of the wine.

In accordance with the present invention, an image of a wine label can be scanned and stored automatically without pushing a shutter to avoid the image blur problem.

What is claimed is:

1. A wine label image identifying method comprising:
capturing a target image by a mobile device;
sampling multiple first points in an upper reference zone of the target image and sampling multiple second points positioned in a lower reference zone of the target image;
determining whether a first average gray scale value of the multiple first points and the multiple second points is lower than a first gray scale threshold;
sampling multiple third points of the target image when the first average gray scale value is lower than the first gray scale threshold;
determining whether a second average gray scale value of the multiple third points is higher than a second gray scale threshold;
when the second average gray scale value is higher than the second gray scale threshold, confirming that a wine label is captured in the target image.

2. The method as claimed in claim 1, wherein the first average gray scale value is calculated by dividing a sum of all gray scale values of the first points and all the second points by a total number of the first points and the second points.

3. The method as claimed in claim 2, wherein the second average gray scale value is calculated by dividing a sum of all gray scale values of the third points by a total number of the third points.

4. The method as claimed in claim 2, wherein each one of the first points and the second points comprises one or more pixels of the target image.

5. The method as claimed in claim 3, wherein each one of the third points comprises one or more pixels of the target image.

6. The label image identifying method as claimed in claim 1, wherein the first average gray scale value is 50.

7. The label image identifying method as claimed in claim 1, wherein the second average gray scale value is 65.
